(19) United States
(12) Patent Application Publication
(10) Pub. No.: US 2026/0319093 A1
(43) Pub. Date: Oct. 15, 2026

(54) TECHNIQUES FOR ESTIMATING DETECTION RANGE IN LIGHT DETECTION AND RANGING (LIDAR) SYSTEMS

(71) Applicant: Aeva, Inc., Mountain View, CA (US)

(72) Inventors: Kshitij Jain, Fremont, CA (US); Jose Krause Perin, Mountain View, CA (US); Kumar Bhargav Viswanatha, Santa Clara, CA (US); James Reuther, San Francisco, CA (US); Mina Rezk, Haymarket, VA (US)

(21) Appl. No.: 19/175,135

(22) Filed: Apr. 10, 2025

(51) Int. Cl. G01S 17/89; B60W 60/00; G01S 7/481; G01S 7/497; G01S 17/58; G01S 17/931

(52) U.S. Cl. CPC G01S 17/89; G01S 7/4813; G01S 7/4817; G01S 7/497; G01S 17/58; G01S 17/931; B60W 60/00; B60W 2420/408; G01S 2007/4975

(57) ABSTRACT

A light detection and ranging (LIDAR) technique that includes transmitting an optical beam comprising an up-chirp and a down-chirp. The field of view (FOV) of the LIDAR may include a plurality of regions arranged in a two-dimensional grid. The technique also includes receiving a return optical beam based on the optical beam, computing a point based on the return optical beam, and adding the point to a point cloud, wherein the point comprises a range and a velocity. The technique also includes receiving a parameter describing operating conditions of the LIDAR system. The technique also includes determining an estimated signal-to-noise ratio (SNR) drop associated with the parameter and determining an estimated detection range of the LIDAR system based on the estimated SNR drop. The parameter and the estimated detection range are associated with one of the plurality of regions of the FOV.

### TECHNICAL FIELD

The present disclosure is related to light detection and ranging (LIDAR) systems in general, and more particularly to estimating detection range limits for LIDAR systems.

### BACKGROUND

Frequency-Modulated Continuous-Wave (FMCW) LIDAR systems use tunable lasers for frequency-chirped illumination of targets, and coherent receivers for detection of backscattered or reflected light from the targets that are combined with a local copy of the transmitted signal. Mixing the local copy with the return signal, delayed by the round-trip time to the target and back, generates a beat frequency at the receiver that is proportional to the distance to each target in the field of view of the system. These systems can be used on autonomous vehicles for navigation purposes. Such LIDAR systems may sometimes be subjected to conditions (e.g., rain, fog, etc.) that create challenges for generating accurate object detections.

### BRIEF DESCRIPTION OF THE DRAWINGS

For a more complete understanding of the various examples, reference is now made to the following detailed description taken in connection with the accompanying drawings in which like identifiers correspond to like elements.

FIG. 1 is a block diagram of an example LIDAR system according to example implementations of the present disclosure.

FIG. 2 is a time-frequency diagram of FMCW scanning signals that can be used by a LIDAR system according to some embodiments of the present disclosure.

FIG. 3A is a graph illustrating a relationship between signal-to-noise ratio (SNR) and detection range according to some embodiments of the present disclosure.

FIG. 3B is a graph illustrating a relationship between probability of detection (PD) and SNR according to some embodiments of the present disclosure.

FIG. 4 is a block diagram illustrating an example of a detection range processing unit for a LIDAR system according to some embodiments of the present disclosure.

FIG. 5 is a more detailed example of a detection range processing unit, in accordance with some embodiments of the present disclosure.

FIG. 6 is a process flow diagram of an example method of operating an FMCW LIDAR system, according to some embodiments of the present disclosure.

### DETAILED DESCRIPTION

The present disclosure describes various examples of LIDAR systems and methods for detecting distance and relative speed of objects. More specifically, the present disclosure describes improved techniques for estimating a detection range for a LIDAR system, i.e., the maximum distance at which objects can be detected with a requisite probability of detection. FMCW LIDAR performance can be affected by many internal and external parameters. For example, the aging of LIDAR system components may tend to reduce signal quality and increase noise. Additionally, external conditions such as rain or fog may cause multi-return detections and/or loss of signal strength over distance. A reduction in performance caused by such conditions may cause a loss in probability of detection, increase false alarms, and increased range and velocity error.

The present disclosure describes various examples of LIDAR systems and methods that are configured to generate an estimated detection range based on various internal factors (e.g., component aging) and external factors (e.g., weather). According to some embodiments, the described LIDAR system may be implemented in any sensing market, such as, but not limited to, transportation, manufacturing, metrology, medical, virtual reality, augmented reality, and security systems. According to some embodiments, the described LIDAR system is implemented as part of a front-end of frequency modulated continuous-wave (FMCW) device that assists with spatial awareness for automated driver assist systems, or self-driving vehicles.

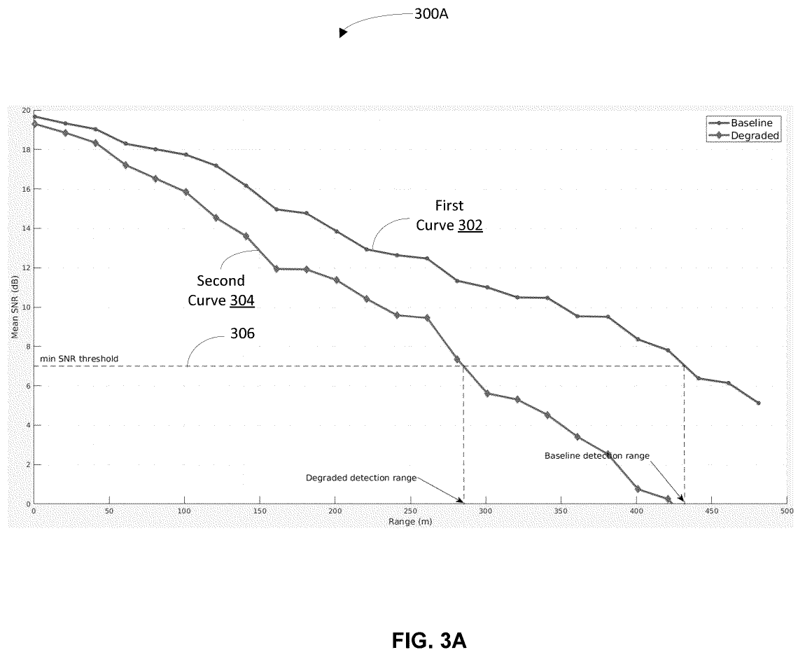

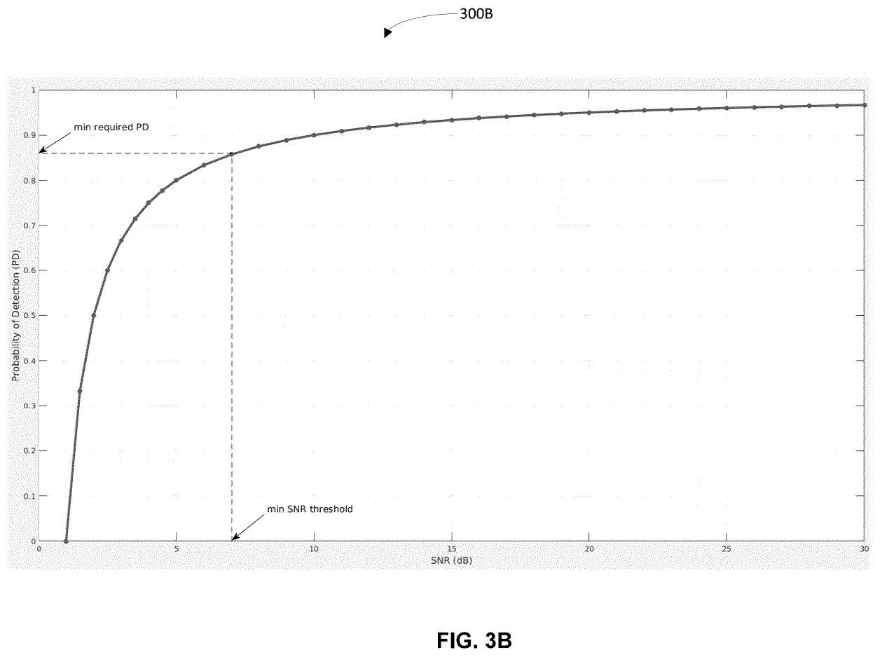

For a laser beam traveling in free space, the ratio of the received power to the transmitted power is inversely proportional to the range of the target. As the power received by the LIDAR system decreases, the intensity of the return signal decreases, which in turn reduces its SNR and the probability of detecting the target declines as described in FIG. 3B Thus, the detection range of the LIDAR system can be determined by performing SNR measurements during calibration of the LIDAR device and applying a minimum SNR threshold corresponding to the requisite PD, as described further in relation to FIG. 3A and FIG. 3B.

During operation of the LIDAR system in accordance with embodiments, various external and internal parameters of the LIDAR system may be monitored to determine a level of SNR degradation that is associated with the monitored parameters. The SNR degradation may be used to determine a corresponding decrease in the detection range. In this way, the detection range may be periodically updated to respond to new conditions, such as aging of components within the LIDAR system, weather conditions in the external environment, and others. Additionally, some of the monitored parameters may be specific to certain areas within the field of view (FOV) of the LIDAR system. Thus, different detection ranges can be computed for different areas of the field of view. In some embodiments, the field of view may be divided into a two-dimensional grid of regions and detection ranges are generated for each region, creating a map of detection ranges that cover the FOV.

The map of detection ranges may be used by the LIDAR system to control operating parameters of the LIDAR system, such as the scanning mirror speed, laser power modulation scheme, and others. The map of detection ranges may also be sent to external systems such as a vehicle navigation system or driver assistance system. For example, if the map of detection ranges indicates poor visibility due to weather conditions, an alert may be delivered to a driver. In the case of autonomous driving, the indication of poor visibility may trigger a mitigation action, such as reducing the vehicle speed or alerting the driver to take control of the vehicle.

In the following description, reference may be made herein to quantitative measures, values, relationships or the like. Unless otherwise stated, any one or more if not all of these may be absolute or approximate to account for acceptable variations that may occur, such as those due to engineering tolerances or the like. These values may also be scaled or shifted depending on the Lidar parameters. Any quantitative measures are examples to demonstrate relationships rather than requirements of the invention.

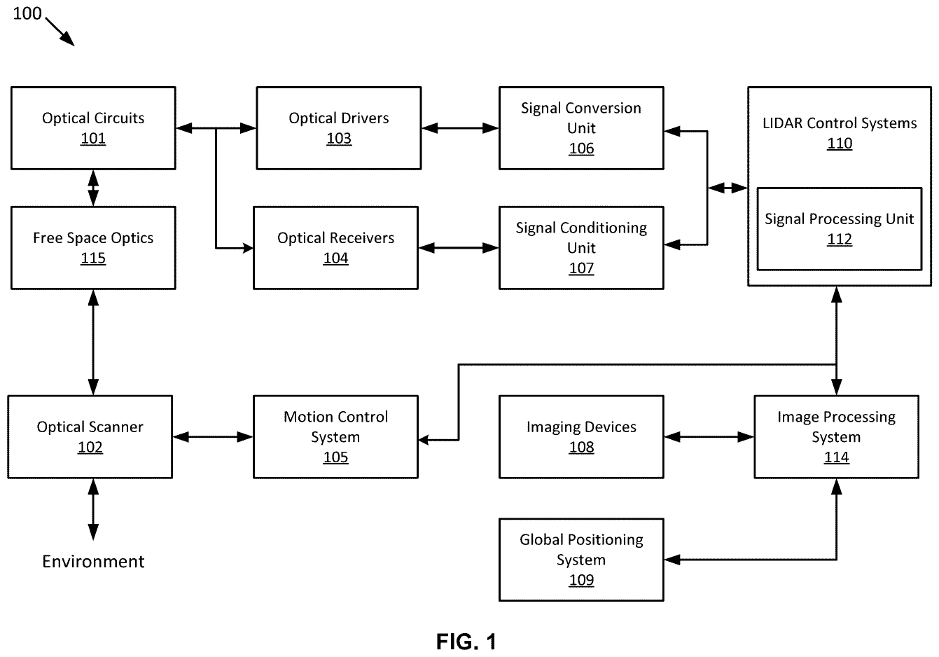

FIG. 1 is a block diagram of an example LIDAR system 100 according to example implementations of the present disclosure. The LIDAR system 100 includes one or more of each of a number of components but may include fewer or additional components than shown in FIG. 1. As shown, the LIDAR system 100 includes optical circuits 101 implemented on a photonics chip. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like.

Free space optics 115 may include one or more optical waveguides to carry optical signals, and route and manipulate optical signals to appropriate input/output ports of the active optical circuit. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles along an axis (e.g., a fast-axis).

In some examples, the LIDAR system 100 includes an optical scanner 102 that includes one or more scanning mirrors that are rotatable along an axis (e.g., a slow-axis) that is orthogonal or substantially orthogonal to the fast-axis of the diffractive element to steer optical signals to scan an environment according to a scanning pattern. For instance, the scanning mirrors may be rotatable by one or more galvanometers. Objects in the target environment may scatter an incident light into a return optical beam or a target return signal. The optical scanner 102 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 102 may include components such as a quarter-wave plate, lens, anti-reflective coated window or the like.

To control and support the optical circuits 101 and optical scanner 102, the LIDAR system 100 includes LIDAR control systems 110. The LIDAR control systems 110 may include a processing device for the LIDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LIDAR control systems 110 may include a signal processing unit 112 such as a DSP. The LIDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LIDAR control systems 110 are also configured to output digital control signals for the optical scanner 102. A motion control system 105 may control the galvanometers of the optical scanner 102 based on control signals received from the LIDAR control systems 110. For example, a digital-to-analog converter may convert coordinate routing information from the LIDAR control systems 110 to signals interpretable by the galvanometers in the optical scanner 102. In some examples, a motion control system 105 may also return information to the LIDAR control systems 110 about the position or operation of components of the optical scanner 102. For example, an analog-to-digital converter may in turn convert information about the galvanometers' position to a signal interpretable by the LIDAR control systems 110.

The LIDAR control systems 110 are further configured to analyze incoming digital signals. In this regard, the LIDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LIDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LIDAR control systems 110. In some examples, the signals from the optical receivers 104 may be subject to signal conditioning by signal conditioning unit 107 prior to receipt by the LIDAR control systems 110. For example, the signals from the optical receivers 104 may be provided to an operational amplifier for amplification of the received signals and the amplified signals may be provided to the LIDAR control systems 110.

In some applications, the LIDAR system 100 may additionally include one or more imaging devices 108 configured to capture images of the environment, a global positioning system 109 configured to provide a geographic location of the system, or other sensor inputs. The LIDAR system 100 may also include an image processing system 114. The image processing system 114 can be configured to receive the images and geographic location and send the images and location or information related thereto to the LIDAR control systems 110 or other systems connected to the LIDAR system 100.

In operation according to some examples, the LIDAR system 100 is configured to use nondegenerate optical sources to simultaneously measure range and velocity across two dimensions. This capability allows for real-time, long-range measurements of range, velocity, azimuth, and elevation of the surrounding environment.

In some examples, the scanning process begins with the optical drivers 103 and LIDAR control systems 110. The LIDAR control systems 110 instruct the optical drivers 103 to independently modulate one or more optical beams, and these modulated signals propagate through the passive optical circuit to the collimator. The collimator directs the light at the optical scanning system that scans the environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected back from the environment pass through the optical circuits 101 to the receivers. Because the polarization of the light has been transformed, it may be reflected by a polarization beam splitter along with the portion of polarized light that was reflected back to the optical circuits 101. Accordingly, rather than returning to the same fiber or waveguide as an optical source, the reflected light is reflected to separate optical receivers. These signals interfere with one another and generate a combined signal. Each beam signal that returns from the target produces a time-shifted waveform. The temporal phase difference between the two waveforms generates a beat frequency measured on the optical receivers (photodetectors). The combined signal can then be reflected to the optical receivers 104.

The analog signals from the optical receivers 104 are converted to digital signals using ADCs. The digital signals are then sent to the LIDAR control systems 110. A signal processing unit 112 may then receive the digital signals and interpret them. In some embodiments, the signal processing unit 112 also receives position data from the motion control system 105 and galvanometers (not shown) as well as image data from the image processing system 114. The signal processing unit 112 can then generate a 3D point cloud with information about range and velocity of points in the environment as the optical scanner 102 scans additional points. The signal processing unit 112 can also overlay a 3D point cloud data with the image data to determine velocity and distance of objects in the surrounding area. The system also processes the satellite-based navigation location data to provide a precise global location.

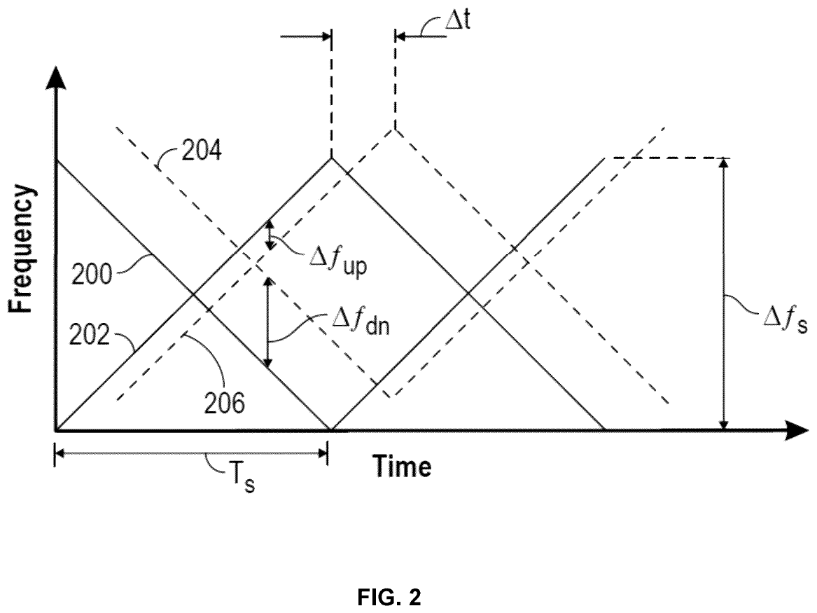

FIG. 2 is a time-frequency diagram of FMCW scanning signals that can be used by a LIDAR system according to some embodiments of the present disclosure. The FMCW scanning signals 200 and 202 may be used in any suitable LIDAR system, including the system 100, to scan a target environment. The scanning signal 200 may be a triangular waveform with an up-chirp and a down-chirp having a same bandwidth Δfₛ and period Tₛ. The other scanning signal 202 is also a triangular waveform that includes an up-chirp and a down-chirp with bandwidth Δfₛ and period Tₛ. However, the two signals are inverted versions of one another such that the up-chirp on scanning signal 200 occurs in unison with the down-chirp on scanning signal 202.

FIG. 2 also depicts example return signals 204 and 206. The return signals 204 and 206, are time-delayed versions of the scanning signals 200 and 202, where Δt is the round-trip time to and from a target illuminated by scanning signal 201. The round-trip time is given as Δt=2R/v, where R is the target range and v is the velocity of the optical beam, which is the speed of light c. The target range, R, can therefore be calculated as R=c(Δt/2).

In embodiments, the time delay Δt is not measured directly but is inferred based on the frequency differences between the outgoing scanning waveforms and the return signals. When the return signals 204 and 206 are optically mixed with the corresponding scanning signals, a signal referred to as a “beat frequency” is generated, which is caused by the combination of two waveforms of similar but slightly different frequencies. The beat frequency indicates the frequency difference between the outgoing scanning waveform and the return signal, which is linearly related to the time delay Δt by the slope of the triangular waveform.

If the return signal has been reflected from an object in motion, the frequency of the return signal will also be affected by the Doppler effect, which is shown in FIG. 2 as an upward shift of the return signals 204 and 206. Using an up-chirp and a down-chirp enables the generation of two beat frequencies, Δfᵤₚ and Δf_{dn} (also referred to herein more simply as fᵤₚ and f_{dn}). The beat frequencies Δfᵤₚ and Δf_{dn} are related to the frequency difference caused by the range, Δf_{Range}, and the frequency difference caused by the Doppler shift, Δf_{Doppler}, according to the following formulas:

Δfᵤₚ=Δf_{Range}+Δf_{Doppler} Eq. 1

Δf_{dn}=Δf_{Range}−Δf_{Doppler} Eq. 2

Thus, the beat frequencies Δfᵤₚ and Δf_{dn}, can be used to differentiate between frequency shifts caused by the range and frequency shifts caused by motion of the measured object. Specifically, the difference between the Δfᵤₚ, and Δf_{dn} is 2Δf_{Doppler} and Δf_{Range}, is the average of Δfᵤₚ and Δf_{dn}.

The range to the target and velocity of the target can be computed using the following formulas:

$$Range = Δ {f}_{range} \frac{{cT}_{s}}{2 Δ {f}_{s}} \qquad Eq . 3$$

$$Velocity = Δ {f}_{Doppler} \frac{{λ}_{c}}{2} \qquad Eq . 4$$

In the above formulas, λ_{c}=c/f_{c} and f_{c} is the center frequency of the scanning signal.

Equations (3) and (4) can be also be expressed as follows:

$$Range = α \cdot ( {f}_{up} + {f}_{dn} ) \qquad Eq . 5$$

$$Where , α = \frac{{cT}_{s}}{4 Δ {f}_{s}}$$

$$Velocity = β \cdot ( {f}_{up} - {f}_{dn} ) \qquad Eq . 6$$

$$Where , β = \frac{{λ}_{c}}{4}$$

The beat frequencies can be generated, for example, as an analog signal in optical receivers 104 of system 100. The beat frequency can then be digitized by an analog-to-digital converter (ADC), for example, in a signal conditioning unit such as signal conditioning unit 107 in LIDAR system 100. The digitized beat frequency signal can then be digitally processed, for example, in a signal processing unit, such as signal processing unit 112 in system 100.

In some scenarios, to ensure that the beat frequencies accurately represent the range and velocity of the object, beat frequencies can be measured at the same moment in time, as shown in FIG. 2. Otherwise, if the up-chirp beat frequency and the down-chirp beat frequencies were measured at different times, quick changes in the velocity of the object could cause inaccurate results because the Doppler effect would not be the same for both beat frequencies, meaning that equations (1) and (2) above would no longer be valid. To measure both beat frequencies at the same time, the up-chirp and down-chirp can be synchronized and transmitted simultaneously using, for example, two signals that are multiplexed together.

FIG. 3A is a graph 300A illustrating a relationship between signal-to-noise ratio (SNR) and detection range according to some embodiments of the present disclosure. The graph 300 is a plot of mean SNR in decibels versus range in meters. The graph 300A also depicts a pair of SNR versus range curves computed under controlled measurement conditions for a LIDAR system. A first curve 302 represents the baseline performance of a new LIDAR system. A second curve 304 represents the degraded performance of the LIDAR system due to aging of the LIDAR components (e.g., lasers, etc.). Each data point in each curve represents the mean SNR measured for a plurality of object detections given a known target having a known reflectivity and placed at various known distances from the LIDAR system.

The first curve 302 may be computed during a calibration process to establish a baseline detection range of the LIDAR system. As used herein, the term “detection range” refers to a range limit, beyond which objects will be estimated to have a probability of detection (PD) below a specified threshold. In some embodiments, the detection range may be defined as the distance at which a target with a 10% reflectivity will have an 80% probability of detection (PD). However, the criteria for defining the detection range may vary depending on the design details of a specific implementation.

The baseline detection range may be established by comparing the first curve 302 of baseline performance to a specified SNR threshold 306. In this example, the specified SNR threshold is 7 decibels (dB). However, other SNR thresholds may be specified depending in part on the desired probability of detection used to define the detection range. The baseline detection range is provided by the point at which the mean SNR curve 302 intersects with the SNR threshold 306. In the example shown, the baseline detection range is approximately 430 meters. In some embodiments, the baseline detection range may be stored in a memory device of the LIDAR system for use by the detection range processing unit 122.

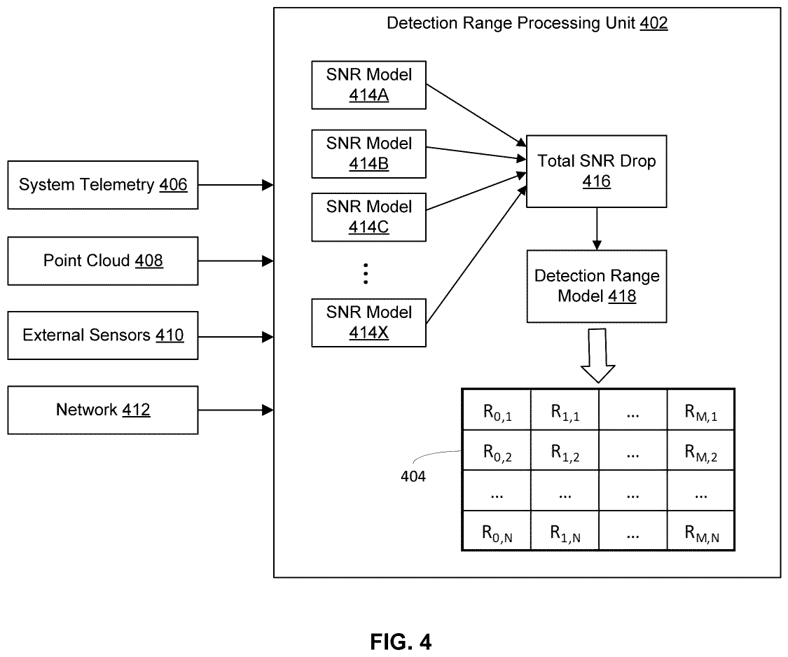

As shown by the second curve 304, a drop in the mean SNR results in a corresponding drop in the detection range. Specifically, with degraded performance, the mean SNR falls below the SNR threshold 306 at a lower detection range (approximately 280 meters in this example). SNR versus range curves such as those shown in FIG. 3A may be used to generate a detection range model that provides an estimated detection range as a function of an estimated SNR drop attributable to one or more internal or external parameters affecting the LIDAR system. The detection range model may be included in the LIDAR system and used to estimate the detection range of the LIDAR system as described further in relation to FIG. 4.

FIG. 3B is a graph 300B illustrating a relationship between probability of detection (PD) and SNR according to some embodiments of the present disclosure. The graph 300B corresponds to a receiver operating characteristic (ROC) curve of a LIDAR system (e.g., a LIDAR system described herein). In the graph 300B, “min SNR threshold” corresponds to an SNR at a minimum required PD.

FIG. 4 is a block diagram illustrating an example of a detection range processing unit 402 for a LIDAR system according to some embodiments of the present disclosure. The detection range processing unit 402 and any of its constituent components may reside in computer memory (e.g., RAM, ROM, flash memory, and the like) resident on the LIDAR control system 110. For example, the detection range processing unit 402 may be included in the signal processing unit 112 of FIG. 1. However, embodiments of the present disclosure are not limited as such.

The detection range processing unit 402 includes the functionality to estimate the detection range of the LIDAR system under current operating conditions. In some embodiments, the detection range processing unit 402 monitors internal and external parameters of the LIDAR system and periodically updates the detection range based on changing conditions such as changing weather conditions, aging of the LIDAR system components, window blockage, etc. Additionally, the estimated detection range can be computed individually for separate regions of the LIDAR system's field of view (FOV) and used to populate a detection range map 404.

Internal parameters of the LIDAR system may include system telemetry 406 related to various components of the LIDAR system. For example, the system telemetry 406 may describe conditions of the optical components (e.g., lasers, optical amplifiers, photonics chip, etc.) such as laser temperature, amplifier temperature, circuit board temperature, photonics chip temperature, laser power, laser quality (e.g., frequency locking quality), and others. The system telemetry 406 may also describe conditions related to the scanning system, such as scanning speed (e.g., polygon and/or galvo speed), number of scan lines, and others. Internal parameters of the LIDAR system may also include the point cloud 408 generated by the signal processing unit 112 and/or various metrics associated with the point cloud.

External parameters of the LIDAR system may include parameters measured by external sensors 410, such as temperature and/or humidity (e.g., the ambient temperature and/or humidity of the outside environment). Data received from external sensors 410 can also include location information provided by a satellite navigation device (e.g., global positioning system (GPS) device). External parameters of the LIDAR system may also include data received from remote computing systems over a network 412 (e.g., the Internet, cellular communication networks, vehicular communication systems, etc.) For example, data received over the network 412 may describe weather conditions at the location of the LIDAR system.

The detection range processing unit 402 may include one or more SNR models 414A-X. Each of the SNR models 414A-X is used to determine a level of SNR degradation to be attributed to the LIDAR system based on the monitored parameters that are associated with that specific SNR model. The parameters received by the detection range processing unit 402 may be associated with an SNR model that describes a relationship between the parameter or a combination of parameters and the corresponding level of expected SNR degradation.

The SNR models 414A-X may include any type of model that is suitable for relating to the specific parameter or combination of parameters to the level of expected SNR degradation. Some SNR models 414A-X may be generated, at least in part, based on experimental data relating to previous measurements of similar LIDAR systems. The SNR models 414A-X may include machine learning models such as artificial neural networks trained using the historical data, a lookup table populated based on the historical data, one or more equations developed to fit the historical data (e.g., through curve fitting for example), and others, including combinations thereof.

Each SNR model 414A-X may return a different level of SNR degradation. Depending on the type of SNR model, the SNR degradation may be different for different regions of the FOV or may apply to all regions of the FOV equally. For example, parameters related to component aging may be applied to the entire FOV, while parameters related to a specific region of the FOV (e.g., specific regions of the point cloud) may be applied to that region of the FOV.

The SNR degradation values returned by each of the SNR models 414A-X for a specific region of the FOV may be summed to determine a total SNR drop 416 for that region. The total SNR drop 416 for that region may then be input to a detection range model 418, which receives the total SNR drop 416 and provides an estimated detection range for that region of the FOV. The detection range model 418 describes the relationship between total SNR drop 416 and detection range, an example of which is described in the graph of FIG. 3A.

The detection range model 418 may include any type of model that is suitable for relating the SNR degradation to the estimated detection range. Some detection range models 418 may be generated, at least in part, based on experimental data relating to previous measurements of similar LIDAR systems. The detection range model 418 may include a machine learning model such as an artificial neural network trained using the historical data, a lookup table populated based on the historical data, one or more equations developed to fit the historical data (e.g., through curve fitting), and others, including combinations thereof.

The detection ranges computed by the detection range model 418 may be stored to a shared memory or otherwise provided to other systems, including other components of the LIDAR system 100 (e.g., LIDAR control system 110) and external components such as an Advanced Driver-Assistance System (ADAS) and Autonomous Driving Systems (ADS), among others. In some embodiments, the detection ranges may be stored as a detection range map 404 that divides the FOV of the LIDAR system into several regions, where each region is associated with its own detection range (R_{M,N}) computed based on the parameters applicable for that region. The detection ranges may be computed periodically. For example, new detection ranges may be computed for each new instance of the point cloud. Additionally, the regions of the detection range map 404 may be resized in response, for example, to a change in user settings, environmental conditions, operating parameters of the LIDAR system, etc.

The detection range map 404 may be used by the LIDAR system to control operating parameters of the LIDAR system. For example, based on one or more regions of the FOV having a detection range below a threshold, the laser power may be increased and/or or the speed of the optical scanning system may be reduced, both of which may tend to increase the signal-to-noise ratio of the received signals and increase the detection range.

Additionally, the detection range map 404 may be used by the LIDAR system to adjust the chirp slope to improve the range resolution in certain directions. The range resolution refers to the sharpness of the resulting image in the outward direction, which is related to the shortest distance over which the LIDAR is able to distinguish between points at different ranges. As explained further below in relation to FIG. 2, FMCW LIDAR system uses a pair of counter-chirped optical signals to measure both range and velocity of a detected object. Accordingly, the laser frequency is ramped up (increasing frequency) and ramped down (decreasing frequency) over time by optical drivers 103, with the ramp up and ramp down repeating in a series over time. The ramp rate of the chirp, i.e., rate of frequency change of the laser light, may be phase locked to a reference frequency, which determines the chirp slope. A low chirp slope increases the maximum effective range of the LIDAR system, enabling the LIDAR system to “see” farther away, but also reduces the range resolution. A high chirp slope reduces the maximum effective range of the LIDAR system but increases the range resolution. If the chirp slope is set for a maximum detection range that is significantly greater than the estimated detection range determined by the detection range processing unit 402, this may result in a low range resolution without any corresponding benefit with regard to the actual detection range. The detection range map 404 can be used to adjust the chirp slope so that the maximum detection range determined by the chirp slope more closely matches the estimated detection range determined by the detection range processing unit 402, thereby improving the range resolution within the estimated detection range.

The map of detection ranges may also be sent to external systems such as a vehicle navigation system (e.g., ADS) or advanced driver-assistance system (e.g., ADAS). For example, if the detection range map 404 indicates poor visibility due to weather conditions, an alert may be delivered to a driver via the driver assistance system. In the case of autonomous driving, the indication of poor visibility may trigger a mitigation action, such as reducing the vehicle speed or alerting the driver to take control of the vehicle.

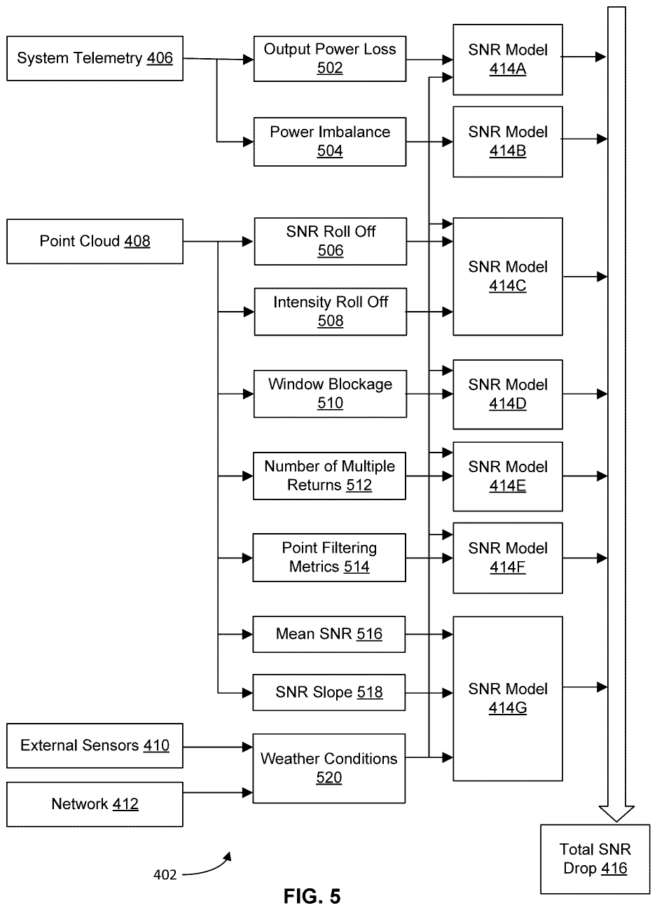

As described further below in relation to FIG. 5, the detection range map 404 may indicate a window blockage, i.e., an obstruction on the LIDAR window that blocks a portion of the LIDAR's FOV. In such cases, the power modulation of the LIDAR system may be controlled to divert power away from the affected regions. Additionally, the vehicle navigation system may be instructed not to rely on LIDAR outputs describing the affected regions indicated by the detection range map 404. Depending on the severity of the blockage, the driver assistance system may be controlled to deliver an alert to the driver to take control of the vehicle, or possibly stop the car to clear the blockage. Other uses of the detection range map are also possible within the scope of the present disclosure.

FIG. 5 is a more detailed example of a detection range processing unit, in accordance with some embodiments of the present disclosure. FIG. 5 shows various types of SNR models that can be used to determine the total SNR drop 416 applicable to the LIDAR system. However, it will be appreciated that embodiments of the present techniques may include additional SNR models beyond those described in relation to FIG. 5. Additionally, some embodiments may include fewer than all of the SNR models shown in FIG. 5.

As shown in FIG. 5, the detection range processing unit 402 may include a SNR model 414A that provides a level of SNR degradation relative to an output power loss 502 of the LIDAR system. The output power refers to the power of the optical signal emitted into the environment by the LIDAR system. As the LIDAR system ages, the output power may tend to decrease. For example, the output of optical sources (e.g., lasers) and optical amplifiers may tend to decrease, and other components of the optical chip may tend to attenuate more of the optical energy output by the optical sources. As the output power decreases, the SNR also decreases.

The output power loss 502 may be determined using various measured parameters included in the system telemetry 406. For example, the output power of each optical source may be measured using internal power monitors. Additionally, laser quality can be measured to determine the deviation of the up-chirp or down-chirp from linearity. Such phase non-linearities may also increase with age and contribute to reductions in the output power. In some embodiments, temperature sensors may be used to determine the temperature at various points in the system, such as the photonics chip and others. Increases in temperature over reference may indicate an increase in the amount of optical power lost to unwanted heating effects within the system. These measured parameters may be combined to compute an estimate for the output power loss 502 in the LIDAR system. The output power loss 502 may be provided as input to the SNR model 414A, which generates a corresponding SNR drop to be attributed to the output power loss 502.

The detection range processing unit 402 may include a SNR model 414B that provides a level of SNR degradation relative to a power imbalance 504 of the LIDAR system. The power imbalance 504 refers to the imbalance in the power of the pair of optical beams that form the counter-chirped signals described in relation to FIG. 2. This type of power imbalance can decrease performance of the LIDAR system. Such power imbalances may be caused by aging of components or adverse environmental conditions within the LIDAR system such as high temperature and/or high humidity.

The power imbalance 504 may be determined from the system telemetry 406 by measuring the output power of each optical source (e.g., laser) or optical amplifier within a signal pair. The power imbalance 504 may be provided as input to the SNR model 414b, which generates a corresponding SNR drop to be attributed to the power imbalance 504. Due to potential variations in LIDAR performance at different azimuths and elevations, the SNR drop to be attributed to the power imbalance 504 may be computed for each FOV region separately.

The detection range processing unit 402 may also include one or more SNR models related to metrics that can be derived from the point cloud 408. The point cloud 408 may be a previous frame of the point cloud generated by the signal processing unit 112.

In some embodiments, the detection range processing unit 402 includes an SNR model 414C that provides a level of SNR degradation relative to an SNR roll off 506 and/or intensity roll off 508 of the LIDAR system. Roll off refers to the inherent reduction in the SNR and intensity of the optical signals received by a LIDAR system as the range to target increases. While some degree of roll off is inevitable, the relationship between the roll off and the range may tend to change depending on aging of the LIDAR system and environmental conditions that affect visibility.

The SNR roll off 506 may be determined by processing statistical data about the individual points in the point cloud 408. For example, each point in the point cloud may have an associated SNR and/or signal intensity that was determined (e.g., computed, measured) for the point based on the received signals used to generate the point. The SNR and range for a plurality of points may be used to generate a roll off curve that describes the mean SNR as a function of range. Similarly, the intensity and range for a plurality of points may be used to generate a roll off curve that describes the mean intensity as a function of range. The SNR roll off 506 and the intensity roll off 508 may refer to any suitable parameter or parameters that can be used to characterize a roll off curve, including the gradient of the roll off curve, a range intercept of the roll off curve for a specific decibel level, and others.

The SNR roll off 506 and/or intensity roll off 508 may be provided as input to the SNR model 414C, which generates a corresponding SNR drop to be attributed to the SNR roll off 506 and/or intensity roll off 508. The SNR model 414C may be generated by determining a baseline roll off curve (e.g., curve 302 of FIG. 3A), which may be stored to memory. The SNR model 414C may determine the SNR drop by comparing the SNR roll off and/or intensity roll off currently indicated by the point cloud with the baseline values. The roll off curves and the corresponding SNR drop can be computed for each region of the FOV separately or for the entire FOV combined.

In some embodiments, the detection range processing unit 402 includes an SNR model 414D that provides a level of SNR degradation related to a window blockage 510 of the LIDAR system. To protect the optical, electro-optical and mechanical components of LIDAR systems deployed in harsh outdoor environments, the optical beams are usually transmitted through sealed windows. In such systems, the optical beams may occasionally become obstructed by rain, water droplets, mud, road salt, insects or other debris, which can block or attenuate the optical beams. Since the geometry of the LIDAR system is known, including the distance of the LIDAR window from the optical source, any beat frequencies below a given threshold frequency may be identified as being associated with a LIDAR window blockage. Unless filtered out, such beat frequencies may appear as points in the point cloud. Depending on the nature of blockage, some portion of the emitted optical beam may pass through the blocked areas. For example, a thin film of condensation on the LIDAR window may allow a considerable portion of the emitted signal to pass through, while debris such as leaves or paper may only allow a small portion of the energy to pass through if any. The amount of power blocked at any point in the point cloud may be described as the blockage intensity.

During operation of the LIDAR system, the point cloud 408 may be processed (e.g., by a separate window blockage utility) to identify the window blockage 510. The window blockage 510 may be a parameter that describes a level of window blockage applicable to regions of the FOV. For example, the window blockage for a specific region of the FOV may be expressed as a ratio of blocked to unblocked portions within the FOV. The window blockage 510 may also describe an overall level of power reduction in the outgoing beams given the ratio of blocked areas and the respective blockage intensities.

The window blockage 510 may be provided as input to the SNR model 414D, which generates a corresponding SNR drop to be attributed to the window blockage 510. For example, the SNR model 414D may provide a predetermined SNR drop to be associated with regions of the FOV affected by a window blockage. In some embodiments, the SNR model 414D may provide an SNR drop that is proportional to the blockage intensity measured for the regions of the FOV affected by the window blockage.

In some embodiments, the detection range processing unit 402 includes an SNR model 414E that provides a level of SNR degradation related to a number of multiple returns included in the point cloud. A multiple return refers to the presence of multiple viable frequency peaks (i.e., beat frequencies) for the same ray. Multiple returns may be caused when the emitted optical beam is returned by rain, fog, or other particles in the environment in addition to the target object. The conditions that cause multiple returns reduce signal quality and therefore also reduce detection distance.

The presence of multiple returns may be determined by processing the point cloud 408 to identify points having a different range but the same or similar elevation and azimuth angle. The number of multiple returns 512 may be provided as input to the SNR model 414E, which generates a corresponding SNR drop to be attributed to the number of multiple returns 512. The SNR model 414E may be generated by measuring the effects of multiple returns on SNR in a controlled setting using known target distances for example.

In some embodiments, the detection range processing unit 402 includes an SNR model 414F that provides a level of SNR degradation related to point filtering metrics 514. Point cloud filtering is a process of excluding certain detections from the point cloud (e.g., removing points from the point cloud) based on characteristics of the point or the corresponding signals that indicate that the point may be a false detection. Various factors may cause false detections, including doppler effects, negative frequency aliasing, echoes caused by reflective surfaces, and other environmental conditions, such as weather-related conditions such as rain. Various techniques exist for filtering out false detections from the point cloud. For example, a point may be identified as a false detection by computing a degree of variance between a property (e.g., velocity, intensity, etc.) of the point and the corresponding properties of neighboring points. Points that have a degree of variance above a threshold may be identified as noise and filtered out of the point cloud. Variance can also be an indicator of adverse weather conditions. For example, signal returns caused by rain drops tend to create points with a high degree of velocity variance. Thus, certain point filtering metrics 514 may also coincide with a reduction in SNR and detection distance.

During operation of the LIDAR system, one or more point filtering metrics 514 may be determined by processing the point cloud 408. For example, points that have been filtered out may be flagged or otherwise identified as false detections. Additionally, a point cloud filtering algorithm may keep track of various filtering statistics, such as the number of points filtered per frame of the point cloud. The point filtering metrics 514 may be provided as input to the SNR model 414F, which generates a corresponding SNR drop to be attributed to the point filtering metrics 514. The SNR model 414F may be generated by measuring the relationship between the point filtering metrics 514 and the corresponding drop in SNR or detection range in a controlled setting using known target distances for example. The point filtering metrics 514 and the corresponding SNR drop can be computed for each region of the FOV separately or for the entire FOV combined.

The detection range processing unit 402 can also include an SNR model 414G that provides a level of SNR degradation attributable to weather conditions (e.g., rain, fog) as indicated by the mean SNR 516 and/or SNR slope 518 computed from the point cloud 408 and other external data received from external sensors 410 and/or a network 412. Certain weather conditions such as rain and fog tend to reduce the mean SNR applicable to points in the point cloud. Additionally, the SNR tends to drop off more steeply in such weather conditions, resulting in a steeper SNR slope.

During operation of the LIDAR system, the detection range processing unit 402 can process the point cloud 408 to determine the mean SNR 516 and/or SNR slope 518 of points in the point cloud. The mean SNR 516 and/or SNR slope 518 may be provided as input to the SNR model 414G, which generates a corresponding SNR drop that can be attributed to adverse weather conditions. The SNR model 414G may be generated by measuring the relationship between the mean SNR 516, SNR slope 518 and the corresponding drop in SNR or detection range in a controlled setting using known target distances for example. The SNR model 414G may also be generated based on historical data collected during operation of similar LIDAR systems in uncontrolled outdoor environments.

In some cases, a change in the mean SNR 516 and/or SNR slope 518 may also be the result of other internal or external parameters affecting the LIDAR system. If changes in the mean SNR or SNR slope are not the result of adverse weather, the SNR drop computed by the SNR model 414G may not accurately represent the effect on the detection range caused by the mean SNR 516 and/or SNR slope 518. To ensure that the drop in mean SNR 516 or increase in the SNR slope 518 is attributable to adverse weather conditions, the external data provided by the external sensors 410 and/or network 412 may be used to identify current weather conditions 520. For example, the external sensors 410 may be used to detect the temperature and humidity in the environment outside the LIDAR system or to detect the presence of water on an outside surface of the LIDAR system housing. In some embodiments, the external sensors 410 may include a location sensor (e.g., GPS sensor) to determine a geographical location of the LIDAR system. The location information may be used to obtain weather data from a weather service through the network 412.

The weather conditions 520 may be used as an additional input to the SNR model 414G to determine whether the SNR model 414G is activated, i.e., generates an SNR drop. For example, if the weather conditions 520 indicate clear weather, the SNR model 414G may be deactivated, e.g., the SNR drop generated by the SNR model 414G may be set to zero regardless of the mean SNR 516 or the SNR slope. If the weather conditions 520 indicate adverse weather, the SNR model 414G may be activated so that the SNR model 414G generates an SNR drop based on the mean SNR 516 and/or the SNR slope as described above.

In some aspects, the weather condition 520 may be used as an additional input to the SNR model 414A, the SNR model 414B, the SNR model 414C, the SNR model 414D, and/or the SNR model 414F to determine whether the SNR model 414A, the SNR model 414B, the SNR model 414C, the SNR model 414D, and/or the SNR model 414F are activated, i.e., generates an SNR drop. Additionally, the weather condition 520 may be used as an independent input parameter which is used in conjunction with other input parameters to compute an SNR drop in each of the aforementioned models.

The SNR drop provided by each of the SNR models 414A-G are summed to generate a total SNR drop 416, which is provided as input to the detection range model 418 described in relation to FIG. 4. Embodiments of the present techniques may include additional SNR models beyond those described in relation to FIG. 5. Additionally, in some embodiments, one or more of the SNR models 414A-G may be switched on or off based on a user configuration setting and/or depending on the operating conditions of the LIDAR system.

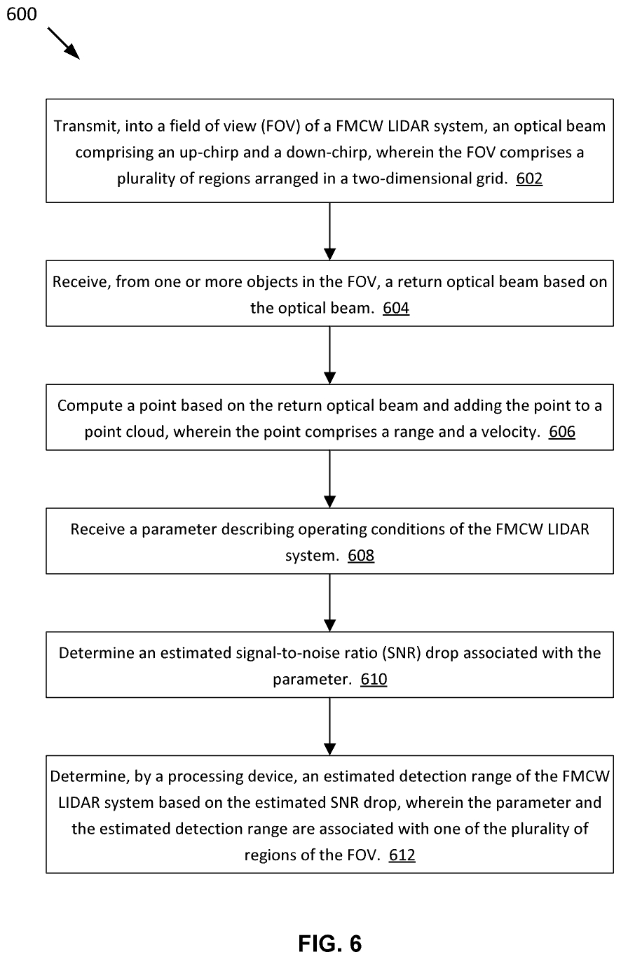

FIG. 6 is a process flow diagram of an example method of operating an FMCW LIDAR system, according to some embodiments of the present disclosure. The method 600 may be performed by any suitable LIDAR system, including the LIDAR system 100 described above. For example, the method may be performed, at least in part, by the detection range processing unit 402 shown in FIG. 4. The method may begin at block 602.

At block 602, an optical beam having an up-chirp and a down-chirp is transmitted into a field of view (FOV) of a FMCW LIDAR system, wherein the FOV comprises a plurality of regions arranged in a two-dimensional grid. The optical beam may include a pair of counter-chirped optical signals that originate from different optical sources, which are combined to form the optical beam.

At block 604, a return optical beam is received from one or more objects in the FOV based on the optical beam.

At block 606, a point is computed based on the return optical beam and the point is added to a point cloud, wherein the point comprises a range and a velocity. For example, the return beam may be combined with local oscillators to generate beat frequencies corresponding with the up-chirp and down-chirp. In some aspects, multiple points are computed based on the return optical beam and the multiple points are added to a point cloud, where each point in the multiple points comprises a range and a velocity.

At block 608, a parameter describing operating conditions of the FMCW LIDAR system is received. The parameter may be an internal parameter relating to operating conditions of the LIDAR system or an external parameter relating to conditions in the external environment.

At block 610, an estimated signal-to-noise ratio (SNR) drop associated with the parameter is determined. The SNR drop may be determined using an SNR model (e.g., SNR models 414A-G) created to associate the parameter with a level of SNR degradation as described above (e.g., using experimental or historical data). It will be appreciated that additional parameters may also be input to the SNR model to generate the SNR drop.

At block 612, an estimated detection range of the FMCW LIDAR system is determined, by a processing device, based on the estimated SNR drop, wherein the parameter and the estimated detection range are specific to one of the plurality of regions of the FOV. The estimated detection range may be determined using a detection range model (e.g., detection range model 418) created to associate the SNR drop with a detection range as described above. It will be appreciated that the SNR drop determined at block 610 may be combined with other SNR drops computed for other types of internal or external parameters such that the estimated detection range determined at block 612 is based on the SNR drop determined at block 610 in addition to the other SNR drops (e.g., the total SNR drop 416).

In some embodiments, the estimated detection range determined at block 612 is communicated to an autonomous driving system (ADS) or an advanced driver assistance system (ADAS) to implement a vehicle control action or issue a driver alert, for example. The estimated detection range determined at block 612 may also be used to control features of the LIDAR system. For example, a chirp slope of the up-chirp and the down-chirp may be adjusted based on the estimated detection range to adjust a range resolution of the FMCW LIDAR system. In some embodiments, the estimated detection range is added to a map of detection ranges (e.g., detection range map 404) that provides individualized detection ranges for each region of the FOV of the FMCW LIDAR system.

It will be appreciated that embodiments of the method 600 may include additional blocks not shown in FIG. 6 and that some of the blocks shown in FIG. 6 may be omitted. Additionally, the processes associated with blocks 602 through 612 may be performed in a different order than what is shown in FIG. 6.

The preceding description sets forth numerous specific details such as examples of specific systems, components, methods, and so forth, in order to provide a thorough understanding of several examples in the present disclosure. It will be apparent to one skilled in the art, however, that at least some examples of the present disclosure may be practiced without these specific details. In other instances, well-known components or methods are not described in detail or are presented in simple block diagram form in order to avoid unnecessarily obscuring the present disclosure. Thus, the specific details set forth are merely exemplary. Particular examples may vary from these exemplary details and still be contemplated to be within the scope of the present disclosure.

Any reference throughout this specification to “one example” or “an example” means that a particular feature, structure, or characteristic described in connection with the examples are included in at least one example. Therefore, the appearances of the phrase “in one example” or “in an example” in various places throughout this specification are not necessarily all referring to the same example.

Although the operations of the methods herein are shown and described in a particular order, the order of the operations of each method may be altered so that certain operations may be performed in an inverse order or so that certain operations may be performed, at least in part, concurrently with other operations. Instructions or sub-operations of distinct operations may be performed in an intermittent or alternating manner.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Furthermore, the terms “first,” “second,” “third,” “fourth,” etc. as used herein are meant as labels to distinguish among different elements and may not necessarily have an ordinal meaning according to their numerical designation.

What is claimed is:

1. A method of operating a frequency modulated continuous wave (FMCW) light detection and ranging (LIDAR) system, the method comprising:
transmitting, into a field of view (FOV) of a FMCW LIDAR system, an optical beam comprising an up-chirp and a down-chirp, wherein the FOV comprises a plurality of regions arranged in a two-dimensional grid;
receiving, from one or more objects in the FOV, a return optical beam based on the optical beam;
computing a point based on the return optical beam and adding the point to a point cloud, wherein the point comprises a range and a velocity;
receiving a parameter describing operating conditions of the FMCW LIDAR system;
determining an estimated signal-to-noise ratio (SNR) drop associated with the parameter; and
determining, by a processing device, an estimated detection range of the FMCW LIDAR system based on the estimated SNR drop, wherein the parameter and the estimated detection range are associated with one of the plurality of regions of the FOV.

2. The method of claim 1, comprising communicating the estimated detection range to an autonomous driving system (ADS) or an advanced driver assistance system (ADAS).

3. The method of claim 1, further comprising adjusting a chirp slope of the up-chirp and the down-chirp to adjust a range resolution of the FMCW LIDAR system based on the estimated detection range.

4. The method of claim 1, further comprising adding the estimated detection range to a map of detection ranges that provides individualized detection ranges for each region of the FOV of the FMCW LIDAR system.

5. The method of claim 1, wherein the parameter comprises an output power loss of the optical beam or the power imbalance between a pair of optical sources that generate the optical beam, wherein the output power loss or power imbalance are determined based on system telemetry collected from one or more sensors included in the FMCW LIDAR system.

6. The method of claim 1, wherein the parameter comprises a metric associated with the point cloud, the metric comprising a point filtering metric or a number of multiple returns detected for the point cloud.

7. The method of claim 1, wherein the parameter is a first parameter that describes weather conditions at a geographical location of the FMCW LIDAR system, the method further comprising:
receiving a second parameter that describes a mean SNR computed for the point cloud;
receiving a third parameter that describes an SNR slope computed for the point cloud; and
responsive to the first parameter indicating adverse weather conditions, generating the estimated SNR drop to correspond with the mean SNR and the SNR slope.

8. The method of claim 1, wherein the FMCW LIDAR system comprises a housing with a window through which the optical beam is transmitted, wherein the parameter describes a degree of window blockage.

9. The method of claim 1, wherein determining the estimated detection range of the FMCW LIDAR system based on the estimated SNR drop comprises:
providing the estimated SNR drop as input to a detection range model that correlates SNR drops with corresponding detection ranges of the FMCW LIDAR system.

10. The method of claim 1, wherein the parameter is a first parameter, the method further comprising:
receiving additional parameters and determining additional estimated SNR drops associated with the additional parameters; and
summing the estimated SNR drop with the additional estimated SNR drops to generate a total SNR drop, wherein the estimated detection range of the FMCW LIDAR system is determined from the total SNR drop.

11. A frequency modulated continuous wave (FMCW) light detection and ranging (LIDAR) system, comprising:
an optical scanner to transmit, into a field of view (FOV), an optical beam comprising an up-chirp and a down-chirp, and receive from one or more objects in the field of view a returned optical beam responsive to transmission of the optical beam, wherein the FOV comprises a plurality of regions arranged in a two-dimensional grid; and
a signal processing system configured to:
compute a plurality of points based on the return optical beam and add the plurality of points to a point cloud, wherein each point comprises a range and a velocity;
receive a parameter describing operating conditions of the FMCW LIDAR system;
determine an estimated signal-to-noise ratio (SNR) drop associated with the parameter; and
determine an estimated detection range of the FMCW LIDAR system based on the estimated SNR drop, wherein the parameter and the estimated detection range are associated with one of the plurality of regions of the FOV.

12. The FMCW LIDAR system of claim 11, wherein the signal processing system is to communicate the estimated detection range to an autonomous driving system (ADS) or an advanced driver assistance system (ADAS).

13. The FMCW LIDAR system of claim 11, wherein the signal processing system is to communicate the estimated detection range to a FMCW LIDAR control system, wherein the FMCW LIDAR control system is configured to adjust a chirp slope of the up-chirp and the down-chirp to adjust a range resolution of the FMCW LIDAR system based on the estimated detection range.

14. The FMCW LIDAR system of claim 11, wherein the signal processing system is to add the estimated detection range to a map of detection ranges that provides individualized detection ranges for each region of the FOV of the FMCW LIDAR system.

15. The FMCW LIDAR system of claim 11, comprising one or more sensors configured to collect system telemetry from one or more components of the FMCW LIDAR system, wherein the parameter comprises an output power loss of the optical beam or the power imbalance between a pair of optical sources that generate the optical beam, wherein the output power loss or power imbalance are determined based on the system telemetry.

16. The FMCW LIDAR system of claim 11, wherein the parameter comprises a metric associated with the point cloud, the metric comprising a point filtering metric or a number of multiple returns detected for the point cloud.

17. The FMCW LIDAR system of claim 11, wherein the parameter is a first parameter that describes weather conditions at a geographical location of the FMCW LIDAR system, wherein the signal processing system is further configured to:
receive a second parameter that describes a mean SNR computed for the point cloud;
receive a third parameter that describes an SNR slope computed for the point cloud; and
responsive to the first parameter indicating adverse weather conditions, generate the estimated SNR drop to correspond with the mean SNR and the SNR slope.

18. The FMCW LIDAR system of claim 11, further comprising a housing with a window through which the optical beam is transmitted, wherein the parameter describes a degree of window blockage.

19. The FMCW LIDAR system of claim 11, wherein to determine the estimated detection range of the FMCW LIDAR system based on the estimated SNR drop, the signal processing system configured to:
provide the estimated SNR drop as input to a detection range model that correlates SNR drops with corresponding detection ranges of the FMCW LIDAR system.

20. The FMCW LIDAR system of claim 11, wherein the parameter is a first parameter and the signal processing system configured to:
receive additional parameters and determine additional estimated SNR drops associated with the additional parameters; and
sum the estimated SNR drop with the additional estimated SNR drops to generate a total SNR drop, wherein the estimated detection range of the FMCW LIDAR system is determined from the total SNR drop.
